(19) United States
(12) Patent Application Publication
(10) Pub. No.: US 2008/0266570 A1
(43) Pub. Date: Oct. 30, 2008

(54) DETECTION AND LOCATION OF BREAKS IN DISTRIBUTED BRILLOUIN FIBER SENSORS

(76) Inventors: Omur M. Sezerman, Kanata (CA); Gordon Youle, Stittsville (CA)

Correspondence Address: William A. Blake, Eads Station, P.O. Box 2266, Arlington, VA, 22202, US

(21) Appl. No.: 12/110,157

(22) Filed: Apr. 25, 2008

Related U.S. Application Data
(60) Provisional application No. 60/907,993, filed on Apr. 26, 2007.

(51) Int. Cl. G01N 21/55

(52) U.S. Cl. 356/445

(57) ABSTRACT

An apparatus for an optical time domain analyzer includes a pulsed laser source and a continuous wave (CW) laser source. The apparatus also has a computer readable memory for detection of a reflected pulse of an outgoing pulse from the pulsed laser source, the reflected pulse being reflected from a break in the fiber or an unterminated end of the fiber. In another embodiment, a computer program product having memory with computer readable code embodied therein is provided for determining a distance to a break or fiber end in an optical fiber. The computer program detects an outgoing pulse from a pulsed laser source in an optical time domain analyzer, detects a reflected pulse and determines the timing of the reflected pulse relative to the outgoing pulse.

### CROSS REFERENCE TO RELATED APPLICATIONS

This application claims the benefit, under 35 U.S.C. 119(e), of U.S. Provisional Application No. 60/907,993, filed Apr. 26, 2007, which is hereby incorporated by reference.

### TECHNICAL FIELD

This invention relates to the detection of breaks and locating their positions in the optical fibers that are used with Brillouin Optical Time Domain Analyzers (BOTDA).

### BACKGROUND INFORMATION

In recent years, Brillouin scattering has been used as a means of detecting strain applied to optical fibers. By firmly securing such optical fibers to a structure (such as a pipeline, dam, or bridge, for example), some of the strain in the structure will be passed on to the attached fiber, which can then be monitored to determine the magnitude and location of the strain. Temperature can also be monitored, and under certain conditions, both temperature and strain can be monitored simultaneously.

Brillouin sensors can be used for the detection of corrosion in terms of the strain change on structural surface due to the corrosion of steel induced deformation on the concrete column in large structures. Brillouin fiber optic sensors excel at long distance and large area coverage, such as any application with total lengths in excess of 10 meters. Distributed Brillouin sensors can be used for much broader coverage and can locate fault points not known prior to sensor installation.

Several examples of systems that use Brillouin sensors can be found in the art. One sample system is discussed in U.S. Pat. No. 6,910,803, which relates to oil field applications. This patent teaches the use of fiber optics to sense temperature only. Brillouin scattering is employed and photodiodes and frequency determination are used.

Another example of a system that uses a Brillouin sensor is U.S. Pat. No. 6,813,403, in which large structures are monitored using Brillouin spectrum analysis. A Brillouin scattering sensor is used with two frequency tunable lasers at 1320 nm for strain, displacement and temperature determination based on typical measurements.

As another example, U.S. Pat. No. 6,555,807 teaches an apparatus for sensing strain in a hydrocarbon well. The apparatus uses a DFB laser split into two signals. A returned Brillouin signal is mixed with a reference signal and sent to an analyzer, where the Brillouin frequency shift can be detected.

Brillouin Optical Time Domain Analyzers (BOTDA) are a specific type of Brillouin sensor that uses two laser beams traveling in opposite directions through the sensing fiber. One of the beams is a continuous wave (CW) signal, meaning that its output power level is constant. The other laser must be pulsed, or used with a modulator, to create a brief pulse of light. The pulsed laser beam induces acoustic phonons within the fiber, which in turn interacts with the CW laser beam. This interaction modifies the power in the CW beam, either increasing or decreasing the power in this beam, as a function of location and intensity of applied strain and temperature. When the modified CW signal reaches the end of the fiber (close to pulsed laser), it can be split from the optical fiber and monitored. Based on the fluctuations of the beam relative to the output of the pulsed laser, the amplitude of the strain (or temperature) can be determined, as a function of position within the sensing fiber.

The problem with a BOTDA is that the two laser beams must enter the fiber from opposite ends. If the fiber breaks, as may happen when sensing large strains, further strain and temperature readings are impossible, as Brillouin sensors rely on the interactions between the two beams and their surroundings. With only a single beam, detection of Brillouin scattering cannot take place.

When a fiber in a Brillouin distributed sensor system is broken, the location of the break must be determined if the fiber is to be repaired. This would normally be done by connecting a separate optical time domain reflectometer (OTDR) to the sensing fiber. An OTDR works by sending a pulse of light into a fiber, and measuring the time it takes for the pulse to travel to the break and be reflected back to the OTDR. The time of travel is directly related to the distance to the break.

### SUMMARY OF THE INVENTION

The present device removes the requirement for a separate OTDR by taking advantage of the capability which normally exists within an OTDA, and applying it in a manner which is different from that required by a conventional OTDA.

In one aspect, an apparatus for an optical time domain analyzer is provided, comprising a pulsed laser source, a continuous wave (CW) laser source, a beam splitter for diverting the light from the CW laser source to the detector and a detector for receiving light from the beam splitter. A control system controls the CW laser source and pulsed laser source. The apparatus also has a computer readable memory having recorded thereon statements and instructions for execution by a computer to detect a reflected pulse of an outgoing pulse from the pulsed laser source, the reflected pulse being reflected from a break in the fiber or an unterminated end of the fiber.

In a further aspect, the computer readable memory of the apparatus also has statements and instructions for determining the timing of the reflected pulse, in particular with relativity to the outgoing pulse. The timing information of the reflected pulse can then be converted into a measurement of distance to the break or fiber end.

In another aspect, a computer program product is provided comprising a memory having computer readable code embodied therein, for execution by a CPU, for determining a distance to a break or fiber end in an optical fiber. The code comprises first detection code means for detecting an outgoing pulse from a pulsed laser source in an optical time domain analyzer, second detection code means for detecting a reflected pulse of the outgoing pulse from a break in the fiber and determination code means for determining the timing of the reflected pulse relative to the outgoing pulse.

In a further aspect, the computer program product also has conversion code means for converting the timing into a measurement of distance to the break or fiber end.

### BRIEF DESCRIPTION OF THE DRAWINGS

The following description will be better understood with reference to the drawings in which:

FIG. 1 shows a block diagram of a typical configuration of a BOTDA in its normal, operating state;

FIG. 2 shows a block diagram of a BOTDA system detecting a break in the fiber; and

FIG. 3 shows a typical signal received by the detector, when the fiber is broken or unterminated.

### DETAILED DESCRIPTION OF THE PREFERRED EMBODIMENTS

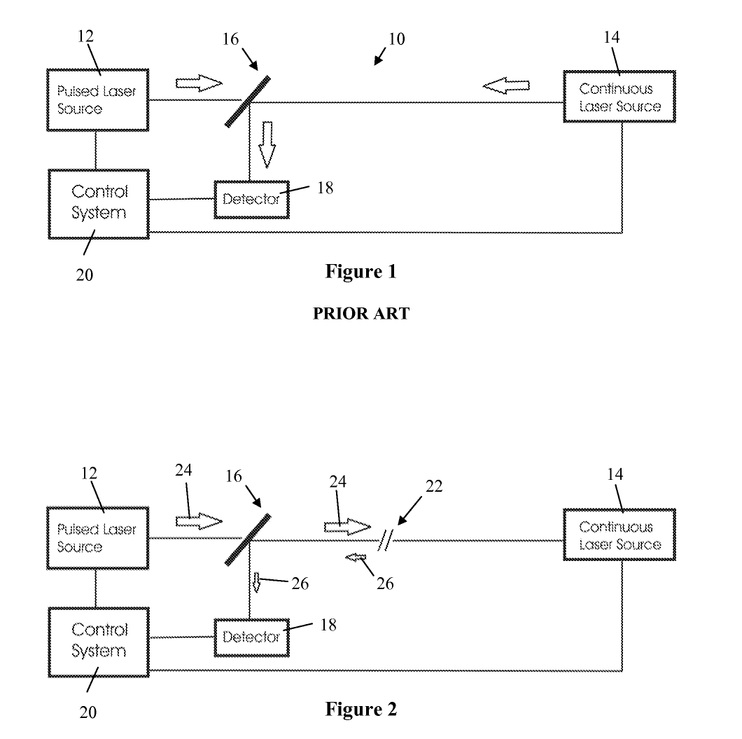

FIG. 1 shows a typical configuration for a BOTDA 10 in its normal, operating state. The pulsed laser source 12 may consist of a pulsed laser or a continuous laser followed by a device to modulate the laser beam. A second, continuous laser beam propagates in a direction opposite to the pulsed beam and is emitted by a continuous laser source 14.

A beam splitter 16 sends the light from the continuous laser source 14 to a detector 18 located close to the launch point of the pulsed beam, i.e. close to the pulsed laser source 12. The light that reaches the detector 18 is primarily from the continuous laser source 14, with a slight amplitude fluctuation caused by the interaction of the two laser beams with the fiber. The control system 20 controls the CW laser source and pulsed laser source, amplifies the output of the detector, digitizes the output of the detector, processes the digitized signal, and communicates with an operator or host computer.

FIG. 2 shows the setup of FIG. 1 with a break 22 in the fiber. Light from the continuous laser source 14 does not propagate beyond the break 22. Outgoing light 24 from the pulsed laser source 12 is reflected by the break 22 back towards the detector 18, as shown by the arrow representing the reflected light 26.

During normal operation, the pulsed beam interacts with the fiber and the continuous wave (CW) beam, causing fluctuations in the CW beam amplitude that vary as a function of the stimulated Brillouin scattering (SBS). The detector 18 and associated circuitry measure the amplitude of variations in the CW beam.

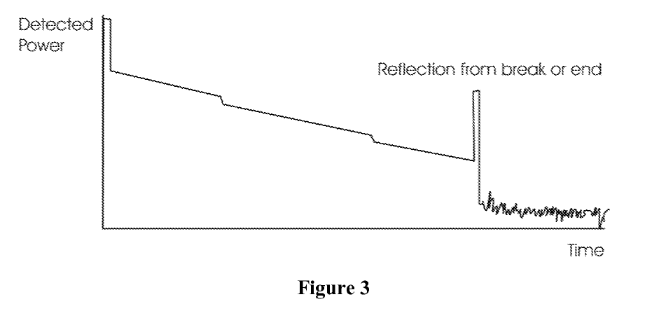

If the fiber is broken, the continuous beam will not substantially propagate beyond the break 22. Light from the pulsed laser source 12 will be reflected at the break 22 in the fiber back to the detector 18. This reflected light 26 can be detected as a pulse of light, with a waveform similar to the incident pulse, but delayed by the time of travel to and from the break. By measuring the time delay of the reflected pulse relative to the original pulse, the distance to the break is determined. FIG. 3 shows a typical signal received by the detector 18, when the fiber is broken or unterminated. The reflected pulse is clearly visible in FIG. 3, with the time delay between the outgoing and reflected pulses being directly proportional to the distance to the point of reflection.

Since both the detector circuitry and the circuitry for generating the laser pulse already exist in the BOTDA, additional circuitry is not required. Detecting the reflected pulse from the break in the fiber then becomes a matter of signal processing, which can be implemented in software, without the need for additional or specialized hardware. Thus, a separate OTDR is not required and time and expense are saved since the distance to the break in the fiber can be determined directly with any pulse from the pulsed laser source after the break occurs.

What is claimed is:

1. An apparatus for an optical time domain analyzer, comprising:
a pulsed laser source;
a continuous wave (CW) laser source;
a beam splitter for diverting the light from the CW laser source to the detector;
a detector for receiving light from the beam splitter;
a control system for controlling the CW laser source and pulsed laser source; and
a computer readable memory having recorded thereon statements and instructions for execution by a computer to detect a reflected pulse of an outgoing pulse from the pulsed laser source, the reflected pulse being reflected from a break in the fiber or an unterminated end of the fiber.

2. The apparatus of claim 1 wherein the computer readable memory has statements and instructions recorded thereon to determine the timing of the reflected pulse.

3. The apparatus of claim 2 wherein the timing of the reflected pulse is relative to the outgoing pulse.

4. The apparatus of claim 3 wherein the timing information of the reflected pulse is converted into a measurement of distance to the break or fiber end.

5. The apparatus of claim 1 wherein the control system is also for amplifying the output of the detector, digitizing the output of the detector, processing the digitized signal, and communicating with an operator or host computer

6. A computer program product, comprising:
a memory having computer readable code embodied therein, for execution by a CPU, for determining a distance to a break or fiber end in an optical fiber, said code comprising:
first detection code means for detecting an outgoing pulse from a pulsed laser source in an optical time domain analyzer;
second detection code means for detecting a reflected pulse of the outgoing pulse from a break in the fiber; and
determination code means for determining the timing of the reflected pulse relative to the outgoing pulse.

7. The computer program product of claim 6 further comprising:
conversion code means for converting the timing into a measurement of distance to the break or fiber end.
